(19) United States
(12) Patent Application Publication
(10) Pub. No.: US 2025/0357464 A1
(43) Pub. Date: Nov. 20, 2025

(54) Electrode for Electrochemical Energy Storage Devices

(71) Applicant: AM Batteries, Inc., Billerica, MA (US)

(72) Inventors: Jay Jie Shi, Acton, MA (US); Omri Flaisher, Litchfield, NH (US); Brandon Ludwig, Manchester, NH (US)

(73) Assignee: AM Batteries, Inc., Billerica, MA (US)

(21) Appl. No.: 18/871,091

(22) PCT Filed: Jun. 2, 2023
(86) PCT No.: PCT/US2023/024272

§ 371 Date: Dec. 2, 2024

Related U.S. Application Data
(60) Provisional application No. 63/348,693, filed on Jun. 3, 2022.

(51) Int. Cl. H01M 4/04; H01M 4/02; H01M 4/36; H01M 4/58; H01M 4/62

(52) U.S. Cl. CPC H01M 4/0457; H01M 4/0471; H01M 4/366; H01M 4/5825; H01M 4/623; H01M 4/625; H01M 2004/021

(57) ABSTRACT

An exemplary method of fabricating an electrode for electrochemical energy storage devices is provided. The method includes forming agglomerates from ultra-fine active particles that include one or more binder I materials. The method includes forming composite particles by combining the agglomerates with one or more binder II materials. The method includes depositing the composite particles onto an electrically conductive substrate through an electrostatic deposition process to form a coating layer. The method includes densifying the coating layer and the electrically conductive substrate to form an electrode.

### CROSS-REFERENCE TO RELATED APPLICATIONS

This application claims priority to and the benefit of U.S. Provisional Patent Application No. 63/348,693, filed on Jun. 3, 2022. The entire content of the foregoing provisional application is incorporated herein by reference in its entirety.

### BACKGROUND

### 1. Technical Field

The present disclosure is directed to systems and methods for manufacture of electrodes having particular utility in electrochemical energy storage devices, e.g., lithium ion batteries, and to advantageous electrodes having beneficial properties/performance attributes.

### 2. Background Art

A Li-ion battery is typically composed of a cathode, anode, separator, and electrolyte. The cathode and anode ca include a composite material layer coated on to a current collector foil. The composite material layer is generally composed of an electrochemically active material along with conductive additives and binder additives.

In a typical Li-ion battery, the common active materials for a cathode are Lithium Nickel-Cobalt-Manganese Oxide (NCM), Lithium Cobalt Oxide (LCO), and Lithium Iron Phosphate (LFP), while the common anode active materials are based on carbonaceous materials, such as graphite, silicon, or Si-based composites. The current collector material for the cathode and anode is typically aluminum and copper, respectively.

The conventional electrode manufacturing method for fabricating cathodes and anodes is referred to as slurry-casting. In slurry-casting, the binder additive material is paired with a liquid such that they can be combined into a homogeneous binder/solvent slurry. Afterwards, the active material and conductive additives are mixed into the slurry. This slurry is then deposited onto the current collector foil and subsequently dried to remove the solvent.

Another method of manufacturing Li-ion batteries involves electrostatic spray deposition (ESD). Articles have disclosed the application of ESD techniques to solvent-free composite electrode coatings for Li-ion batteries. The solvent-free electrode coating technology is attractive since it can significantly reduce energy consumption in the manufacturing process and significantly reduces the manufacturing cost of batteries. In principle, the ESD technique allows a simpler and more flexible electrode coating due to direct deposition of composite electrode powders on a metallic current collector through an electrostatic spray deposition process.

ESD is widely used in dry powder coating for metallic parts. For ESD coating applications, the coating layer quality and transfer efficiency is generally directly related to properties of particles of the coating powder. A typical electrostatic deposition coating process generally includes feeding a coating powder from a hopper to an electrostatic deposition apparatus, fluidizing the powder, electrostatically charging the fluidized powder particles, and allowing the charged particles to flow and travel in an electric field, such that the charged particles reach and deposit onto a grounded electrically conductive substrate.

A typical process for solvent-free electrostatic deposition coating for battery electrode manufacture includes the following processing steps: (a) mixing an electrochemical active material powder, binder material powder and conductive material powder to form a mixture with a defined stoichiometry, (b) feeding and fluidizing the mixture in an electrostatic deposition apparatus, (c) electrostatically charging particles in the fluidized mixture, (d) allowing the charged particles to flow and travel in an electric field, such that the charged particles reach and deposit onto a grounded current collector to form a deposited layer, and (e) heating and compressing the coated current collector to form an electrode. The electrode may then be incorporated into a desired application environment, e.g., the electrode may be used for battery cell manufacturing. Depending on the active material in the deposited layer, the electrode can be a cathode or anode for a battery.

Despite efforts to date, a need remains for improved and cost effective systems/methods for electrode manufacture and for cost effective electrodes that exhibit effective performance properties/characteristics. These and other objectives are achieved according to the systems/methods and electrodes disclosed herein.

### SUMMARY

In accordance with embodiments of the present disclosure, an exemplary method of fabricating an electrode for electrochemical energy storage devices is provided. The method includes forming agglomerates from ultra-fine active particles that include one or more binder I materials. The method includes forming composite particles by combining the agglomerates with one or more binder II materials. The method includes depositing the composite particles onto an electrically conductive substrate through an electrostatic deposition process to form a coating layer. The method includes densifying the coating layer and the electrically conductive substrate to form an electrode.

In some embodiments, an average particle size (D50) of the ultra-fine active particles is less than 5 μm. The ultra-fine active particles are either cathode materials or anode materials. In some embodiments, the cathode materials can be selected from (i) lithium transition metal oxides, lithium transition metal sulfides, lithium polyanion cathode materials, including lithium transition metal phosphates, lithium transition metal silicates, or combinations thereof, or from (ii) sodium transition metal oxide, sodium polyanion cathode material, Prussian Blue Analogues cathode materials, or combinations thereof.

In some embodiments, the anode materials can be selected from (i) carbonaceous anode materials, graphite, Si, Si-based composites, SiOx, lithium alloyable materials, lithium transition metal oxide anode materials, or combinations thereof, or from (ii) sodium ion intercalation anode materials, including Prussian Blue Analogues anodes, and sodium metal transition metal oxide anodes.

In some embodiments, the one or more binder I materials can be selected from one or more of polymeric materials, conductive polymer materials, polymer electrolytes, solid state electrolyte composites, and carbonaceous materials. In some embodiments, the polymeric materials can be selected from polyvinylidene fluoride, polytetrafluoroethylene, polyethylene oxide, poly(methyl methacrylate), polystyrene butadiene rubber binder, carboxymethyl cellulose binder, polyacrylic acid, or combinations thereof. In some embodiments, the one or more binder II materials can be selected from one or more of polymeric materials, polymer electrolytes, solid state electrolyte composites, and carbonaceous materials. In some embodiments, the one or more binder I and the one or more binder II materials can be the same materials. In some embodiments, the one or more binder I and the one or more binder II materials can be different materials.

In some embodiments, the agglomerates can be formed from the one or more binder I materials and one or more additives. In such embodiments, the one or more additives can be electric conductive materials selected from carbon black, carbon nano fiber, carbon nano tube, graphene, graphite, metallic powders, or combinations thereof. In some embodiments, the composite particles can be formed from the one or more binder II materials and one or more additional additives. In such embodiments, the one or more additional additives can be electric conductive materials selected from carbon black, carbon nano fiber, carbon nano tube, graphene, graphite, metallic powders, or combinations thereof. In some embodiments, the additional additives in the agglomerate formulation and the composite particles formulation can be the same. In some embodiments, the additional additives in the agglomerate formulation and the composite particles formulation can be different.

The method can include incorporating the electrode into an assembly selected from a group consisting of a rechargeable lithium battery, a Li-ion battery, a rechargeable lithium sulfur battery, a solid state battery, a rechargeable sodium battery, and a sodium-ion battery.

In accordance with embodiments of the present disclosure, an exemplary electrode is provided as formed by the exemplary methods discussed herein.

In accordance with embodiments of the present disclosure, an exemplary method of making composite particles including ultra-fine active material is provided. The method includes mixing the ultra-fine active materials particles with one or more binder I materials to produce agglomerates. The method includes mixing the agglomerates with one or more binder II materials.

In some embodiments, the method can include mixing the ultra-fine active material particles with the one or more binder I materials and one or more additives to produce the agglomerates. In some embodiments, the method can include mixing the agglomerates with the one or more binder II materials and one or more additional additives. In some embodiments, the one or more binder I materials are added as a dry powder. In some embodiments, the one or more binder I materials are added as a solution. In some embodiments, the one or more binder I materials are added as a suspension. In some embodiments, the mixing is carried out with heating. In some embodiments, the mixing is carried out without heating.

Any combination and/or permutation of embodiments is envisioned. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

To assist those of skill in the art in making and using the electrode and associated systems/methods, reference is made to the accompanying figures, wherein:

FIG. 1A is a diagrammatic view of a dispersion pattern of particles in a composite electrode powder mixture through dry mixing.

FIG. 1B is a diagrammatic view of ultra-fine active material particles processed to form agglomerates with a defined size.

FIG. 1C is a diagrammatic view of composite particles formed by active material agglomerates combined and interacting with binder particles and conductive material particles.

FIG. 2 is a diagrammatic view of stoichiometry of powder in feedstock and a deposited layer.

FIG. 3 is a diagrammatic view of stoichiometry of powder in feedstock and a deposited layer with the composite particles fed into an electrostatic deposition apparatus for fluidization, electrostatic charging and deposition onto a conductive substrate.

FIG. 4A is a particle size distribution (PSD) chart of nickel manganese cobalt oxide (NCM), FIG. 4B is a PSD chart of lithium cobalt oxide (LCO), FIG. 4C is a PSD chart of graphitized carbon (GC), and FIG. 4D is a PSD chart of lithium iron phosphate (LFP).

FIG. 5 is a table of bulk density properties of raw materials.

FIG. 6A is a scanning electron microscopy (SEM) image of raw LFP powder.

FIG. 6B is an SEM image of LFP granule formation after 2 minutes.

FIG. 6C is an SEM image of LFP granule formation after 4 minutes.

FIG. 6D is an SEM image of LFP granule formation after 8 minutes.

FIG. 7 is a table of granulated LFP bulk density and fill ratios.

FIG. 8A is an SEM image of non-granular LFP.

FIG. 8B is an SEM image of small granule LFP/PPA.

FIG. 8C is an SEM image of optimized LFP/PAA granule.

FIG. 8D is an SEM image of LFP/PEO granules mixed with PVDF and C65.

FIG. 9 is a solvent-free manufactured LFP electrode using granulized ultra-fine LFP.

FIG. 10 is a chart of rate performance of LFP electrodes.

FIG. 11A is an SEM image cross-section of a solvent-free LFP electrode using ultra-fine LFP.

FIG. 11B is an SEM image top surface of a solvent-free LFP electrode using ultra-fine LFP.

### DETAILED DESCRIPTION

According to the present disclosure, advantageous systems/methods for solvent-free electrostatic deposition (ESD) coating of battery electrodes are provided that are based on inclusion of ultra-fine particle materials with a high transfer efficiency and uniformity, and techniques for making electrode material particles suitable for the disclosed solvent-free ESD coating process from precursors with ultra-fine active material powder.

A battery typically includes cathode, anode, separator and electrolyte. In a typical battery, the cathode and anode consist of composite electrode powder mixtures and current collectors. A composite electrode powder mixture generally contains active material particles (AM), binder material particles (Binder) and conductive material particles (CB). The active material provides electrochemical activity, e.g., provides energy for a battery. The binder material adheres active material particles and conductive materials in the electrode to enable good mechanical stability, good ionic conduction, and good electrical conduction for the electrode. The conductive material provides electrical conduction in the electrode. Both the binder material and conductive material typically are electrochemically inert in a battery. Thus, the added binder and conductive material in an electrode increases the total weight and volume of a battery, while lowering a battery's gravimetric and volumetric energy density. Both the binder material and conductive material need to exhibit a requisite level of chemical stability and electrochemical stability in a battery to ensure that the battery will exhibit suitable performance and life.

In a typical Li-ion battery, the active electrode materials are cathode materials, such as lithium nickel-cobalt-manganese oxide (NCM) or lithium iron phosphate (LFP), and anode materials based on carbonaceous anode materials, graphite, silicone, or Si-based composites. The current collector for the cathode typically is Al foil, and for the anode it is typically Cu foil. The binder materials are polymeric materials, such as PVDF, PTFE, PEO, PMMA, SBR, CMC, or the like, which are electric insulators. Conductive materials are typically carbon black, carbon nanotubes, or graphene, which are electrically conductive. In addition, functional additives may be included in a typical composite electrode. These additives may be silica, alumina, zirconium oxide or any combination of them. The true density, conductivity and permittivity for active materials, binder materials and conductive materials are significantly different.

The active material mass ratio in a composite electrode is typically above 70% and the binder and conductive material mass ratio is generally less than 30% to enable a sufficient gravimetric and volumetric energy density and good power ability for the battery.

Although Li-ion batteries use NCM cathode or graphite anode materials with a typical particle size of 5-30 μm, in many cases, ultra-fine particle active materials are used to enable a battery to meet performance requirements. The use of ultra-fine particles as the starting material for the disclosed agglomerates advantageously allow electrolyte to readily access the ultra-fine particle, so that the unique and beneficial properties of the ultra-fine particles is preserved in the agglomerate form. For example, the ultra-fine particles offer short diffusion distances and less morphology change, making them beneficial for fast charging or high-power capability. Thus, preservation of the beneficial properties of ultra-fine active particles while overcoming fundamental challenges of solvent-free manufacture of electrodes is fundamental to the present disclosure.

The ultra-fine particle size is hereafter defined as an average particle size of less than 5 μm. For example, carbon coated LFP nanoparticle materials in a size range of 100-1000 nm are used in Li-ion batteries as cathodes due to the intrinsic low electronic and ionic conductivity of non-coated, larger particle size LFP materials. A commercial PVDF binder is usually agglomerated with an average size of 1-30 μm. Some PVDF binder agglomerates include sub-particles with a primary particle size of 100-1000 nm.

For a conventional solvent-based slurry electrode coating technique, the PVDF binder is dissolved in a solvent, NMP. Thus, the sub-particles size of PVDF agglomerate does not significantly affect the binder performance. However, for solvent-free electrode coating using an electrostatic spray deposition technique, the binder in the composite electrode powder mixture consisting of active material, binder and conductive material typically needs to be deagglomerated to form small sub-particles with a particle size of 100-1000 nm to enable an effective bonding function. The conductive carbon particle used either in solvent-based slurry coating or solvent-free ESD coating is also small, typically in the range of 50-1000 nm, to enable an effective conductive network to be established in the electrode.

In the ESD process, the charge of a particle is correlated to its relative permittivity and size through Equation 1:

$$q ( t ) = 4 π {ε}_{0} ( 1 + 2 \frac{{ε}_{r} - 1}{{ε}_{r} + 2} ) {r}^{2} E \frac{enkt}{4 {ε}_{o} + enkt} \qquad ( 1 )$$

where r is the radius of the particle, E is the electric field strength, e is the charge of an electron, k is the electron mobility, n is the electron concentration, t is the time, ε₀ is the absolute permittivity, and εᵣ is the relative permittivity of powder.

Equation 1 shows that the particle charge is proportional to the square of the particle size. Thus, it is expected that ultra-fine particle size significantly reduces its chargeability. The lower chargeability reduces the ability of particles to deposit on the conductive substrate, resulting in a low transfer efficiency and poor uniformity of the coated layer. Furthermore, ultra-fine particles have a very low mass, which results in charged particles flowing in the electric field much more randomly due to aerodynamic force effects. This leads to fewer charged particles reaching the conductive substrate and depositing on it, resulting in a low transfer efficiency.

The transfer efficiency is the ratio of the mass of electrostatically charged particles deposited on the conductive substrate and the total mass of fluidized particles dispensed. A higher transfer efficiency means more particles are deposited onto the conductive substrate, resulting in higher first-pass utilization of coating materials. Thus, a high transfer efficiency for application of ESD technique to solvent-free electrode coating is critical for efficient battery production.

The uniformity of the deposited layer includes the consistency of the chemical stoichiometry between the deposited layer and the feedstock powder mixture, and the consistency of chemical stoichiometric and geometric consistency within the deposited layer. Any non-uniformity of the deposited layer results in non-uniformity of the resultant battery electrode, and ultimately lowers the battery performance. Thus, it is also crucial to ensure high uniformity of the coating layer. In some embodiments, the high uniformity of the coating layer can be the thickness or loading variation of the coating layer in an electrode in Li-ion battery production that is less than ±2%.

The powder fluidization ability and ease of flow in the electric field, called flowability, is affected by the particle size. In general, a smaller particle size has lower flowability, typically driven by a higher degree of Van der Waal force interactions, causing greater powder cohesion. A low particle flowability reduces the quantity of charged particles that flow in the electric field, reach the conductive substrate and deposit on it, resulting in a low transfer efficiency.

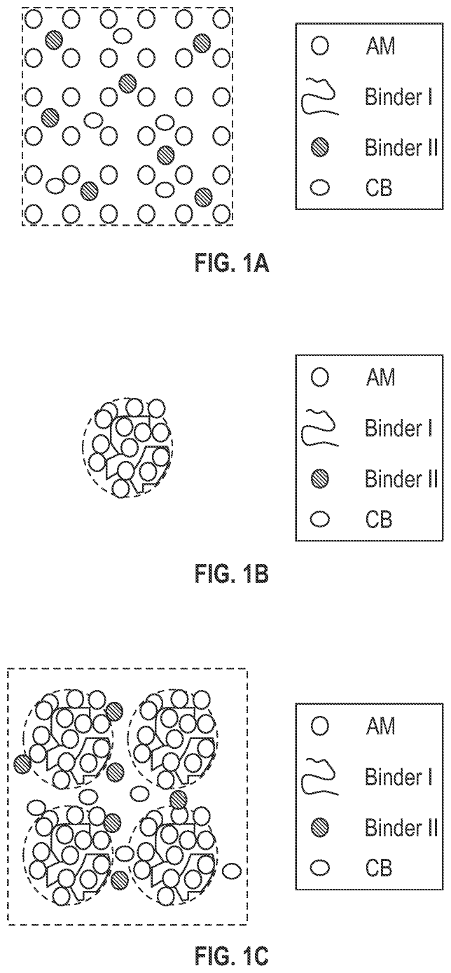

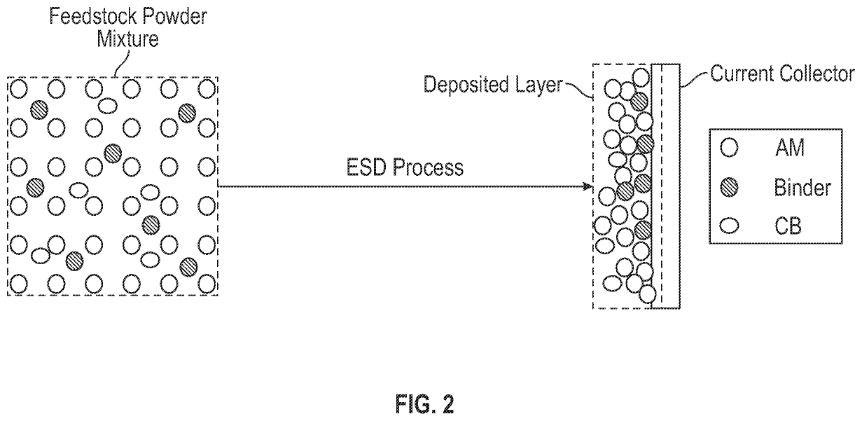

According to the present disclosure, a well-mixed electrode powder mixture with a defined stoichiometry of active material, binder and conductive material, where the active material has an ultra-fine particle size comparable to the ultra-fine particle size of the binder particles and conductive carbon particles, has a particle dispersion pattern as illustrated in FIG. 1A. When depositing the electrode powder mixture on a current collector using the ESD technique, fluidized particles are individually charged, then flow and travel in the electric field, and finally those charged particles that reach the surface of the current collector deposit on it. A low transfer efficiency may be expected due to the low particle chargeability and low powder flowability resulting from the small (ultra-fine) particle size. Furthermore, due to significant differences in conductivity, density, chargeability and flowability between the active material, binder and conductive material particles, the ratio of these particles deposited onto the substrate, or the unit stoichiometry in the deposited layer, deviates from the original mixture, resulting in a non-uniformity in the deposited layer (FIG. 2). The unit volume stoichiometry is defined as the mass ratio of active material, binder and conductive material in unit area with unit thickness from the current collector to the outer surface of the deposited layer. The unit area is defined as 1 cm², and the unit thickness is defined as 50 μm.

In order to solve the issues associated with electrostatic deposition of ultra-fine particle active materials, a novel and advantageous process is disclosed herein.

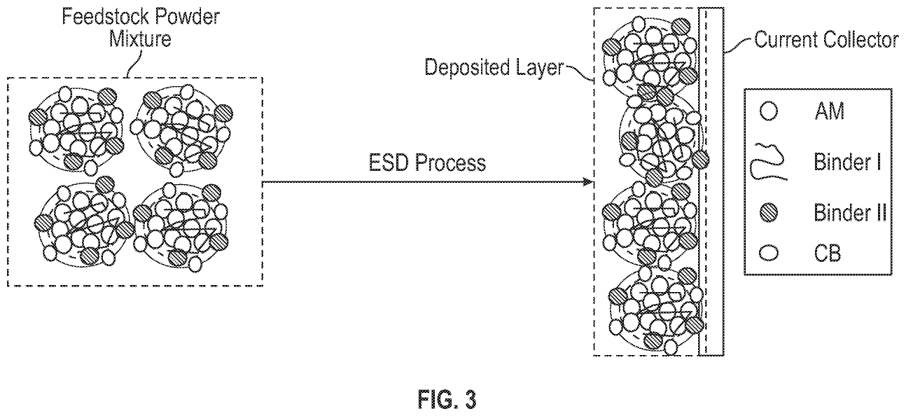

In particular, the disclosed method includes the following steps. In a first step, the method includes ultra-fine active material particles processed to form agglomerates with a defined size (FIG. 1B). The method includes the active material agglomerates combining and interacting with binder particles and conductive material particles to form composite particles (FIG. 1C). The method includes the composite particles being fed into an electrostatic deposition apparatus for fluidization, electrostatic charging and deposition onto a conductive substrate (FIG. 3). The method includes the coated electrode including the deposition layer and conductive substrate being heated and compressed to form an electrode, e.g., a cathode or anode for battery manufacturing. The noted steps may be performed in the order listed above or in a variation of the ordering listed above.

The active material can be any type of cathode or anode materials used for batteries in the industry. Batteries include primary and rechargeable batteries. Rechargeable batteries include Li-ion batteries, rechargeable lithium battery, all solid-state batteries, polymer electrolyte batteries, rechargeable lithium-sulfur batteries, rechargeable sodium batteries and Na-ion batteries. For the convenience of description, Li-ion batteries are used for explanation below. However, it should be understood that the principle and process discussed herein can also be applied to other types of batteries.

The commonly used cathode materials in Li-ion batteries are lithium transition metal oxides, polyanion type cathode materials, including lithium nickel-cobalt-manganese oxide (NCM), lithium iron phosphate (LFP), or the like. The commonly used anode materials in Li-ion batteries are carbonaceous materials, lithium alloy element-based materials, lithium transition metal oxides, including graphite, hard carbon, soft carbon, Si, Si/C composites, SiOx, SiOx/C composites, lithium titanium oxide, or the like.

The exemplary process discussed herein used two binders: binder I and binder II (FIG. 3). The function of binder I is to bond ultra-fine active material particles to form agglomerates. A suitable binder I material needs to have a sufficient bonding ability for ultra-fine particles to form mechanically stable agglomerates, chemical stability with the active material and other ingredients encountering the binder, and electrochemical stability in the operation window for the battery cell. The binder material for use as binder I can be selected from, e.g., polymeric materials, carbonaceous materials, inorganic materials, or the like.

The commonly used polymeric binder I materials for Li-ion batteries according to the present disclosure include polyvinylidene fluoride (PVDF), polytetrafluoroethylene (PTFE), polyethylene oxide (PEO), polyethylene glycol (PEG), carboxymethyl cellulose (CMC), polyacrylic acid (PAA), polymethyl methacrylate (PMMA), styrene-butadiene rubber (SBR), polyethylene (PE), or the like. The binder I materials can also be/include conductive polymers, such as polypyrrole, polyaniline, or the like. The carbonaceous binder can be a carbon network. The inorganic binder materials include lithium polysilicate (Li₂Si₅O₁₁), sodium polyphosphate ((NaPO₃)ₙ), lithium phosphate monobasic (H₂LiPO₄), or the like. In some embodiments, the binder materials can be a polymer electrolyte, a solid electrolyte, or the like.

Most binder I materials are electrochemically inert. The binder I contained in the agglomerates increases the weight and volume, which reduces energy of the active material delivered in a unit weight or unit volume, e.g., the gravimetric energy density and volumetric energy density. For such type of binder materials, a lesser amount of binder I contained in the agglomerates is preferred. Generally, the mass ratio for binder I in the agglomerates is below 30%, and preferably it is not more than 10%. In some embodiments, the mass ratio for binder I in the agglomerates is between about, e.g., 0.1-30% inclusive, 0.2-30% inclusive, 0.3-30% inclusive, 0.4-30% inclusive, 0.5-30% inclusive, 0.6-30% inclusive, 0.7-30% inclusive, 0.8-30% inclusive, 0.9-30% inclusive, 1-30% inclusive, 2-30% inclusive, 3-30% inclusive, 4-30% inclusive, 5-30% inclusive, 10-30% inclusive, 15-30% inclusive, 20-30% inclusive, 25-30% inclusive, 0.1-30% inclusive, 0.1-25% inclusive, 0.1-20% inclusive, 0.1-15% inclusive, 0.1-10% inclusive, 0.1-5% inclusive, 0.1-4% inclusive, 0.1-3% inclusive, 0.1-2% inclusive, 0.1-1% inclusive, 0.1-0.9% inclusive, 0.1-0.8% inclusive, 0.1-0.7% inclusive, 0.1-0.6% inclusive, 0.1-0.5% inclusive, 0.1-0.4% inclusive, 0.1-0.3% inclusive, 0.1-0.2% inclusive, 0.1%, 0.2%, 0.3%, 0.4%, 0.5%, 0.6%, 0.7%, 0.8%, 0.9%, 1%, 2%, 3%, 4%, 5%, 10%, 15%, 20%, 25%, 30%, or the like.

Of note, binder I materials may be selected that exhibit electrochemical activity which contributes electrochemical capacity and energy to the agglomerates. For example, an amorphous carbon binder for a composite anode particle consisting of ultra-fine graphite particles contributes some capacity. In this case, the contribution of electrochemical activity makes it feasible to include more binder I in the agglomerates. Generally, in cases where the binder I materials contribute electrochemical activity, the binder mass ratio in the agglomerates is not more than 50%, and preferably is not more than 30%. In some embodiments, the binder mass ratio is the agglomerates is between about, e.g., 0.1-50% inclusive, 0.2-50% inclusive, 0.3-50% inclusive, 0.4-50% inclusive, 0.5-50% inclusive, 0.6-50% inclusive, 0.7-50% inclusive, 0.8-50% inclusive, 0.9-50% inclusive, 1-50% inclusive, 2-50% inclusive, 3-50% inclusive, 4-50% inclusive, 5-50% inclusive, 10-50% inclusive, 15-50% inclusive, 20-50% inclusive, 25-50% inclusive, 30-50% inclusive, 35-50% inclusive, 40-50% inclusive, 45-50% inclusive, 0.1-45% inclusive, 0.1-40% inclusive, 0.1-35% inclusive, 0.1-30% inclusive, 0.1-25% inclusive, 0.1-20% inclusive, 0.1-15% inclusive, 0.1-10% inclusive, 0.1-5% inclusive, 0.1-4% inclusive, 0.1-3% inclusive, 0.1-2% inclusive, 0.1-1% inclusive, 0.1-0.9% inclusive, 0.1-0.8% inclusive, 0.1-0.7% inclusive, 0.1-0.6% inclusive, 0.1-0.5% inclusive, 0.1-0.4% inclusive, 0.1-0.3% inclusive, 0.1-0.2% inclusive, 0.1%, 0.2%, 0.3%, 0.4%, 0.5%, 0.6%, 0.7%, 0.8%, 0.9%, 1%, 2%, 3%, 4%, 5%, 10%, 15%, 20%, 25%, 30%, 35%, 40%, 45%, 50%, or the like.

In some cases, ultra-fine conductive material particles are incorporated into the active material agglomerate (FIG. 1B) to increase the electrical conduction within the agglomerate. Conductive materials that may be incorporated in the agglomerate according to the present disclosure include carbon black, carbon nanotubes, graphene, conductive polymer particles, or metal powder, which are electrically conductive. The conductive material mass ratio in the agglomerates is generally not more than 10%, not more than 5%, and preferably 0.5-2%. In some embodiments, the conductive material mass ratio in the agglomerates can be about, e.g., 0.1-10% inclusive, 0.2-10% inclusive, 0.3-10% inclusive, 0.4-10% inclusive, 0.5-10% inclusive, 0.6-10% inclusive, 0.7-10% inclusive, 0.8-10% inclusive, 0.9-10% inclusive, 1-10% inclusive, 2-10% inclusive, 3-10% inclusive, 4-10% inclusive, 5-10% inclusive, 6-10% inclusive, 7-10% inclusive, 8-10% inclusive, 9-10% inclusive, 0.1-9% inclusive, 0.1-8% inclusive, 0.1-7% inclusive, 0.1-6% inclusive, 0.1-5% inclusive, 0.1-4% inclusive, 0.1-3% inclusive, 0.1-2% inclusive, 0.1-1% inclusive, 0.1-0.9% inclusive, 0.1-0.8% inclusive, 0.1-0.7% inclusive, 0.1-0.6% inclusive, 0.1-0.5% inclusive, 0.1-0.4% inclusive, 0.1-0.3% inclusive, 0.1-0.2% inclusive, 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, or the like.

The agglomeration of ultra-fine active material particles can be performed by mixing active particles with binder I melt. In an exemplary implementation, at a temperature above the melting point or softening point of binder I, ultra-fine particles are mixed with the melted binder in a mixer. It is desirable that the binder I melting or softening temperature be above room temperature. If the melting or softening temperature is too low, it is likely the agglomeration may not take place. When the melting/softening temperature is too high, it uses a lot of energy which is generally not desirable. A preferred melting/softening temperature range for binder I is between about, e.g., 50° C.-300° C. inclusive, 50° C.-250° C. inclusive, 50° C.-200° C. inclusive, 50° C.-150° C. inclusive, 50° C.-100° C. inclusive, 100° C.-300° C. inclusive, 150° C.-300° C. inclusive, 200° C.-300° C. inclusive, 250° C.-300° C. inclusive, 50° C., 100° C., 150° C., 200° C., 250° C., 300° C., or the like.

In some embodiments, the agglomeration of ultra-fine active material particles can be performed by mixing ultra-fine active material particles with binder I in solution or suspension. The binder I solution or suspension may be introduced into the mixer before mixing or during mixing. The binder I may be dissolved in a solvent or may be suspended in a liquid media. The solvent or liquid media is generally evaporated during mixing with or without heating. The solvent or liquid media can also be removed with heating after the mixing process.

In some embodiments, the agglomeration of ultra-fine active material particles with binder I can be performed using a spray drying method. In an exemplary spray drying implementation, ultra-fine active material particles are suspended in a binder I solution. The suspension is dried through a spray drying process, which generates agglomerates. The ultra-fine active material particles and binder I particles can be homogeneously suspended in a liquid media. The suspension is dried through a spray drying process. In this case, the spray drying temperature is generally close or slightly higher than the melting/softening temperature of the binder I.

In some embodiments, the ultra-fine active material powder may be mixed with one or more precursor(s) to form an agglomerate, and then the mixture may be cured to form a final active material agglomerate for ESD coating. One example is nano-size Si powder and fine graphite powder which are mixed with pitch at a temperature above the softening temperature of pitch to form an initial agglomerate, followed by carbonization at 700° C.-1200° C. to form a Si/C agglomerate for ESD coating.

Under some circumstances, the ultra-fine active material particles can interact with each other through cohesive forces to form mechanically stable agglomerates. No binder I is needed in these cases.

Methods for mixing the ultra-fine active material powder and binder I material can thus be selected from dry powder mixing and wet mixing. A typical dry powder mixing process involves first loading the ultra-fine active material powder and binder I powder in a mixer. The active material powder and the binder I powder combination is then mixed with or without heating. A typical wet mixing process typically entails loading the ultra-fine active material powder in a mixer first, followed by introduction of the binder I solution, suspension or melt into the mixer during mixing. Mixers can be any mechanical mixers and fluidized bed mixers, including impact mixers, shear mixers, such as an Eirich mixer, mechano-fusion mixer, Cycloinix, or the like.

The active material agglomerate formed at least in part from ultra-fine active material particles are further mixed with binder material 11 and conductive materials with a defined stoichiometry to form composite particles according to the present disclosure, as shown in FIG. 1C. In the composite particles, the binder II particles—which typically are characterized by a very small particle size—and the conductive material particles—which are also typically characterized by very small particle size—are adhered on the surface of the active material agglomerates via physical and chemical interactions. The binder II particle size and conductive particle size are generally not more than 1000 nm. In some embodiments, the binder II particle size and conductive particle size can be about, e.g., 30-1000 nm inclusive, 40-1000 nm inclusive, 50-1000 nm inclusive, 60-1000 nm inclusive, 70-1000 nm inclusive, 80-1000 nm inclusive, 90-1000 nm inclusive, 100-1000 nm inclusive, 200-1000 nm inclusive, 300-1000 nm inclusive, 400-1000 nm inclusive, 500-1000 nm inclusive, 600-1000 nm inclusive, 700-1000 nm inclusive, 800-1000 nm inclusive, 900-1000 nm inclusive, 30-900 nm inclusive, 30-800 nm inclusive, 30-700 nm inclusive, 30-600 nm inclusive, 30-500 nm inclusive, 30-400 nm inclusive, 30-300 nm inclusive, 30-200 nm inclusive, 30-100 nm inclusive, 30-90 nm inclusive, 30-80 nm inclusive, 30-70 nm inclusive, 30-60 nm inclusive, 30-50 nm inclusive, 30-40 nm inclusive, 30 nm, 40 nm, 50 nm, 60 nm, 70 nm, 80 nm, 90 nm, 100 nm, 200 nm, 300 nm, 400 nm, 500 nm, 600 nm, 700 nm, 800 nm, 900 nm, 1000 nm, or the like.

The binder II material can be selected from polymeric materials, carbonaceous materials, inorganic materials, or the like (similar material categories to the binder I). Binder I and binder II materials can be the same or different, depending on the materials used, the process conditions, the performance, combinations thereof, or the like.

The conductive material in the composite particle can be carbonaceous materials, such as carbon nanotube, carbon nanofiber, carbon black, graphene, graphite, or the like. It can also be metal particles, such as Al, Cu ultra-fine particles. It can be ultra-fine conductive polymer particles. In some cases, conductive material is not needed, e.g., for a graphite or carbonaceous-based anode, no conductive material is needed in some cases since they are conductive. Thus, the composite particle in these cases only includes active material agglomerate and binder II particles.

The composite particles are typically loaded in a hopper. They are fed into the electrostatic deposition apparatus. In the ESD apparatus, composite particles are first fluidized, then charged via corona charging or a tribo charging method, followed by flowing in the electric field, and finally depositing on the grounded conductive substrate (FIG. 3).

It is crucial that the active material agglomerates do not break up during mixing, fluidization, electrostatic charging, flowing in the electric field and deposition on the conductive substrate. These steps are therefore carefully performed to ensure the integrity of the active material agglomerates. Furthermore, it is important that the composite particles do not break up during mixing, fluidization, flowing and deposition. These steps are therefore carefully performed to ensure the integrity of the composite particles. This enables the unit stoichiometry in the deposited layer to be similar to (e.g., closely approximate) the original stoichiometry in the feedstock powder. The mechanical stability of the active material agglomerates is the key factor to affect/maintain the mechanical stability of the composite particles. The bonding effect of binder I and the density of the active material play critical roles for the mechanical stability of the active material agglomerate. The more pores in the agglomerate, the lower the mechanical stability of the agglomerate. The porosity in the agglomerate generally is not more than 70%. Preferably, the porosity is in the range of about, e.g., 20-70% inclusive, 20-60% inclusive, 20-50% inclusive, 20-40% inclusive, 20-30% inclusive, 30-70% inclusive, 40-70% inclusive, 50-70% inclusive, 60-70% inclusive, 20%, 30%, 40%, 50%, 60%, 70%, or the like.

It is also crucial the composite particles have good chargeability. The good chargeability is achieved through enlarged particles size and adhesion of binder II particles on the surface. The mass of the composite particles is sufficient to avoid significant deviation of charged particles flow away from the deposition path in the electric field. This enables a high transfer efficiency. The active material agglomerate size is in the range of 5-100 μm. Preferably, the active material agglomerate size is in the range of 10-30 μm. In some embodiments, the active material agglomerate size can be in the range of about, e.g., 5-100 μm inclusive, 10-100 μm inclusive, 20-100 μm inclusive, 30-100 μm inclusive, 40-100 μm inclusive, 50-100 μm inclusive, 60-100 μm inclusive, 70-100 μm inclusive, 80-100 μm inclusive, 90-100 μm inclusive, 10-90 μm inclusive, 10-80 μm inclusive, 10-70 μm inclusive, 10-60 μm inclusive, 10-50 μm inclusive, 10-40 μm inclusive, 10-30 μm inclusive, 10-20 μm inclusive, 10 μm, 20 μm, 30 μm, 40 μm, 50 μm, 60 μm, 70 μm, 80 μm, 90 μm, 100 μm, or the like.

The mixing methods that can be employed for making composite particles are similar to the disclosed mixing methods for making active material agglomerates, e.g., using dry powder or wet mixing methods. Preferably, no solvent is used in the mixing process.

In some embodiments, the ultra-fine active material powder is mixed with the 1 binder material (binder I) to form agglomerates. The ultra-fine active material is carbon coated nanoparticle LFP with a particle size of 200-500 nm. The binder I material is selected from PEG, PEO, PE or PVDF. The mass ratio of binder I in the active material and binder powder mixture is 1-10%. The LFP and binder powder are loaded into an impact mixer, such as an Eirich mixer. Powders are mixed in the mixer at a temperature above the binder I melting point, e.g., 70-100° C. for PEG and PEO, 140-150° C. for PE, and 180-200° C. for PVDF.

In some embodiments, carbon coated nanoparticle LFP with a particle size of 200-500 nm is loaded in a mixer. During mixing, 10% PVDF/NMP solution is sprinkled into the powder in the mixer. The mass ratio of dry PVDF in the active material and binder powder mixture is 1-10%. The solvent is evaporated at about 100-150° C. after mixing.

In an exemplary method for downstream processing to make a composite particle powder, the active material agglomerate powder prepared is loaded into a mixer together with PVDF powder with a primary particle size of 100-300 nm and carbon black with a primary particle size of 40-100 nm. The mass ratio of active material agglomerate in the mixture is 80-99%, the mass ratio of PVDF binder is 20-1%, and the mass ratio of carbon black is 20-1%. The mixer may be, for example, an impact or shear mixer.

The composite particle powder is loaded into a hopper. The composite particle powder is fluidized by dry air and flows into a corona charging zone generated by a corona inducing electrode at a voltage of 10-100 kV. The preferred charging voltage is 20-50 kV. The charged composite particles travel in the electric field to reach the grounded Al foil current collector and deposit on the current collector.

The coated electrode consisting of deposited layer and current collector can be first heated at the temperature above the melting point of PVDF, preferably 180-200° C., followed by calendering at temperature of 60-200° C. with a defined calendar force to achieve desired/designed electrode density. The pressed electrode is ready for Li-ion cell assembly.

### Examples

### Example 1

Ninety-eight parts of carbon coated LFP with a particle size of D50 approximately 1-2 μm and two parts of PVDF with a primary particle size of 200-500 nm were mixed in a high shear mixer at 120-170° C. for 10 minutes. When the mixture cooled down, three parts of PVDF and two parts of acetylene carbon black with a primary particle size of 50-80 nm were added and mixed in a high shear mixer at ambient temperature for 10-20 minutes. The morphology of the powder mixtures was investigated by SEM.

The mixed LFP powder was loaded into a hopper in an electrostatic spray deposition system. The dry powder was fluidized by carrying gas under vibration. The fluidized powder was charged by a corona electrostatic spray gun and deposited on a 15 μm thick grounded Al foil. The coating side of the Al foil was pre-coated with a PVDF interface layer with a thickness of less than 1 μm applied by electrostatic spray deposition technique. The deposited sample was heated on a hotplate for about 1 hr at 250° C. to melt the binder. Finally, the annealed sample was pressed using a roller press to a desired thickness to achieve 35% porosity. This electrode sample was ready for SEM/EDS, adhesion and electrochemical characterization.

### Comparison Example

Ninety-three parts of carbon coated LFP with a particle size of D50 approximately 1 μm, five parts of PVDF and two parts of acetylene carbon black were added and mixed in a high shear mixer at ambient temperature for 10-20 minutes. The morphology of the powder mixtures was investigated by SEM.

The mixed LFP powder was loaded into a hopper in an electrostatic spray deposition system. The dry powder was fluidized by carrying gas under vibration. The fluidized powder was charged by a corona electrostatic spray gun and deposited on a 15 μm thick grounded Al foil. The coating side of the Al foil was pre-coated with a PVDF interface layer with a thickness of less than 1 μm applied by electrostatic spray deposition technique. The deposited sample was heated on a hotplate for about 1 hr at 250° C. to melt the binder. Finally, the annealed sample was pressed using a roller press to a desired thickness to achieve 35% porosity. This electrode sample was ready for SEM/EDS, adhesion and electrochemical characterization.

### Granulation Study

In the exemplary manufacturing process, the solvent is completely removed, and the electrode powders (active material, binder and conductive additives) are dry mixed into a uniform mixture. To coat the powder onto the current collector, electrostatic deposition (ESD) is used. In this method, the dry particles are electrostatically charged and deposited onto the grounded current collector. The ability of a particle to charge is dependent on its size where the particle charge is proportional to the square of the particle size.

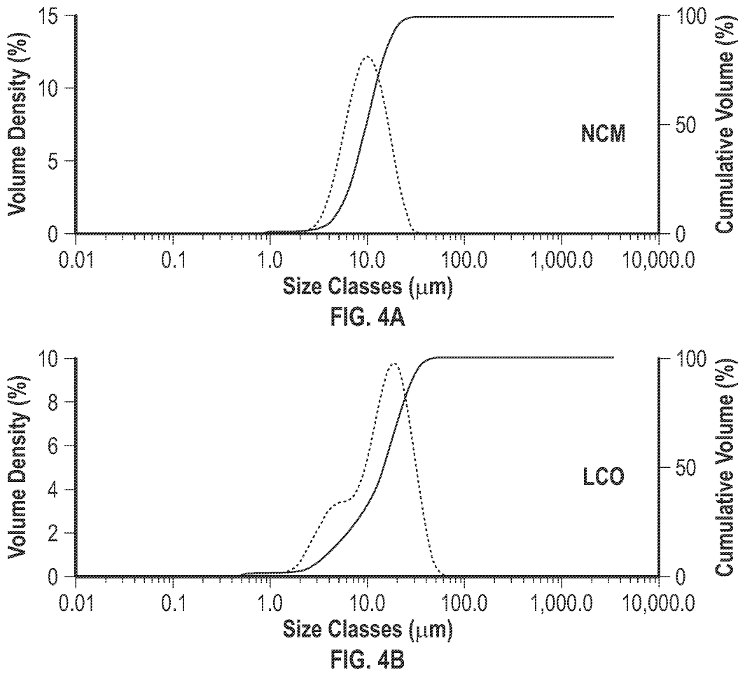

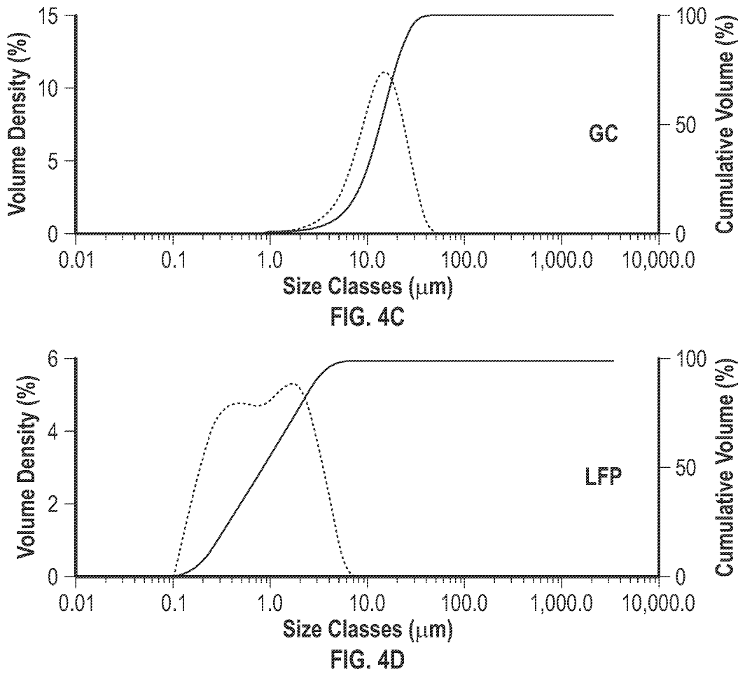

Active materials like NCM, LCO, and graphite have all been used to manufacture solvent free electrodes for batteries. A common characteristic of these materials is that the particle size is in the 5-30 μm range (FIGS. 4A-C). However, some active materials, LFP for example, are typically in the sub-micron size range (FIG. 4D). Since the ability to charge is related to particle size, it is traditionally expected that an LFP based powder mixture will be significantly more difficult to charge. From this point, ultra-fine particles are defined by having a particle size less than 5 μm (as used herein and understood in the industry).

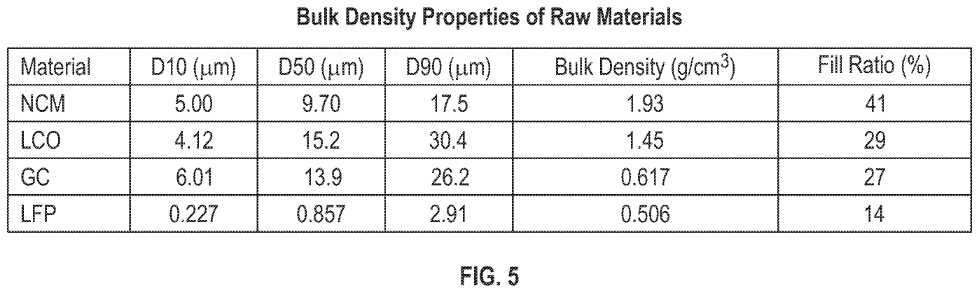

Particle size also impacts the flowability of a powder. For powder feeding and electrostatic deposition, flowability is also critical. Typically, smaller particle sizes lead to less flowability and more cohesiveness. A method of characterizing flowability is by finding the bulk density of the powder system. Based on the results in FIG. 5, it is readily noticeable that the smaller LFP particles lead to a reduced fill ratio (bulk density in relation to its theoretical density). Therefore, when using the LFP based system it can be expected that the processability will be more difficult than the other powder systems.

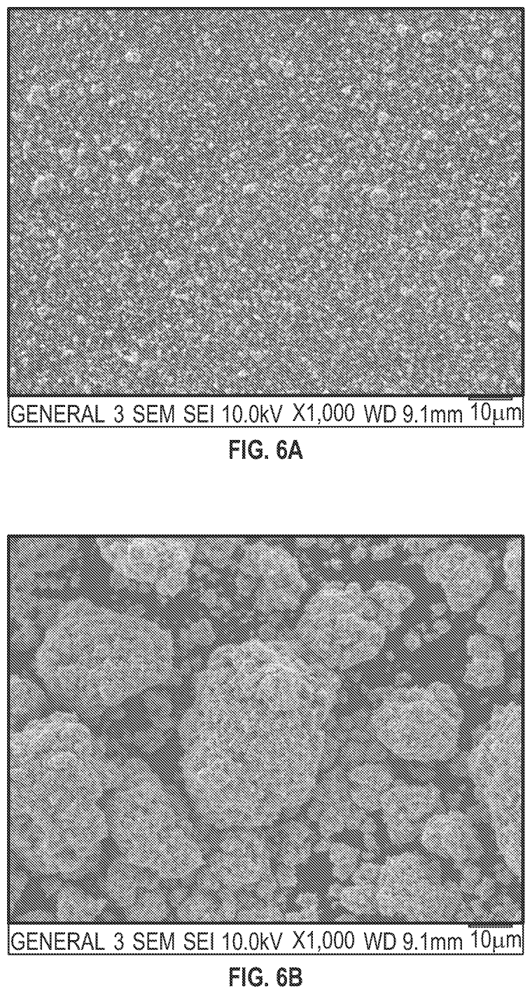

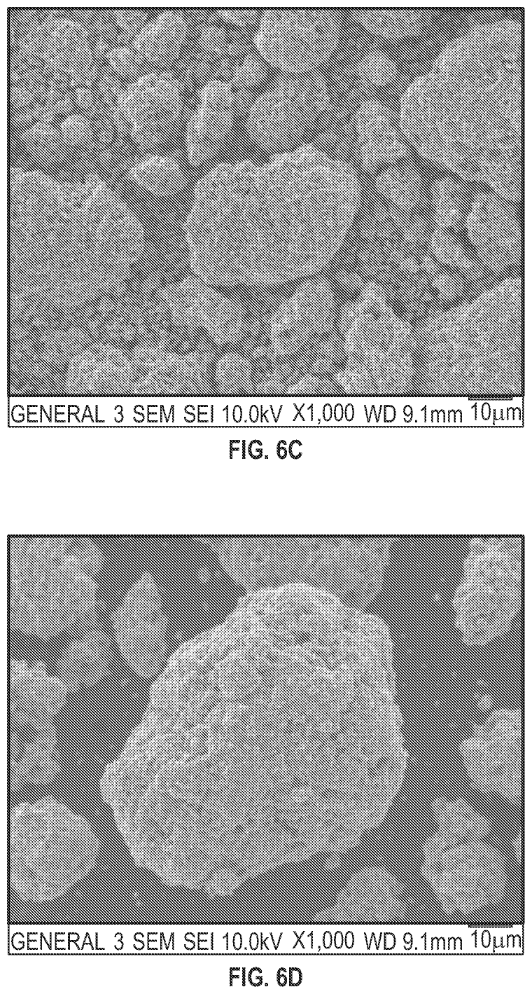

To alleviate this issue, a method of fabricating a composite particle was developed. To achieve this, an ultra-fine particle was combined with a binder material to create a composite particle with increased size. For example, LFP was mixed with Polyacrylic Acid (PAA) as the binder. In this example, PAA was dissolved in water to create a solution with 5 wt % PAA. The solution was added to a mixer containing raw LFP. The liquid/solid ratio for this example was 0.2 (two parts liquid, ten parts LFP). Therefore, the end composition of the LFP/PAA composite particle is 99 wt % LFP and 1 wt % PAA. To understand the granulation process, Scanning Electron Microscopy (SEM) images of raw LFP and LFP/PAA granules were taken. It can be seen (FIG. 6A) that the raw LFP is indeed very small and follows the results of the PSD testing. During the granulation process, several samples were saved to better understand how the granule formation changed over time. It was readily noticeable that granules were forming (FIG. 6B,) but extended mixing time allowed the granules to grow further. The additional time allowed the already formed granules to collect smaller or unformed granules (FIGS. 6C and 6D).

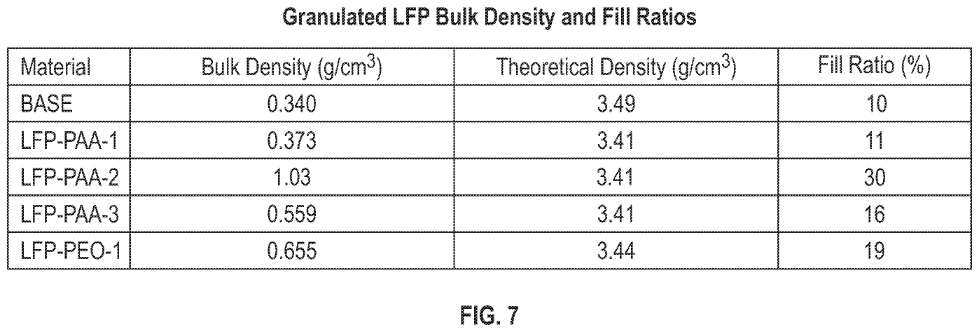

After formation, the granules were mixed with Polyvinylidene Fluoride (PVDF) as the binder and Super C65 Carbon Black (C65) as the conductive additive. When compared to NCM or LCO, PVDF and C65 are significantly smaller in primary particle size at 150 nm and 50 nm, respectively. In a traditional method of mixing PVDF and C65 with NCM or LCO, the goal is to attach the additive materials onto the larger active material particles. Since it would be difficult to achieve this attachment with ultra-fine particles, like raw LFP, achieving granulized LFP particles becomes even more important. To start, the granulized LFP particles were mixed with 2 wt % each of PVDF and C65. It is important to mix at a high enough speed such that secondary additive particles are sufficiently broken down to their primary particle size. For initial electrode production, a high mixing tip speed was used (referred to as LFP-PAA-1). To understand the impact of granulation, bulk density of LFP-PAA-1 was determined along with a baseline mix of 96 wt. % LFP (non-granular), 2 wt. % PVDF, and 2 wt. % C65 (referred to as BASE). The bulk density measurements (FIG. 7) of BASE and LFP-PAA-1 came out to 0.340 g/cm3 and 0.373 g/cm3, respectively. The corresponding fill ratio to the bulk density measurements came to 10% and 11%, respectively. For reference, the fill ratio for a material system with an active material primary particle size in the 5-30 μm range will be in the 20-30% range.

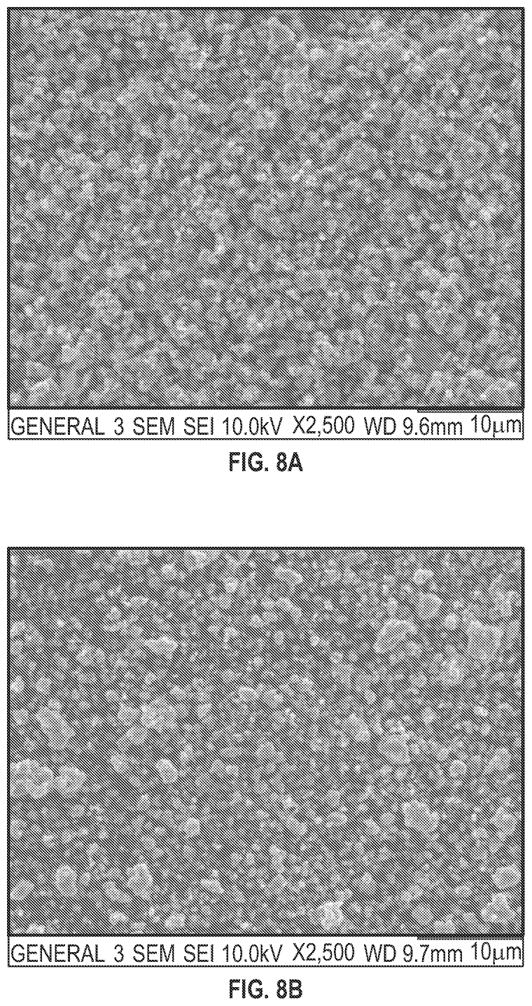

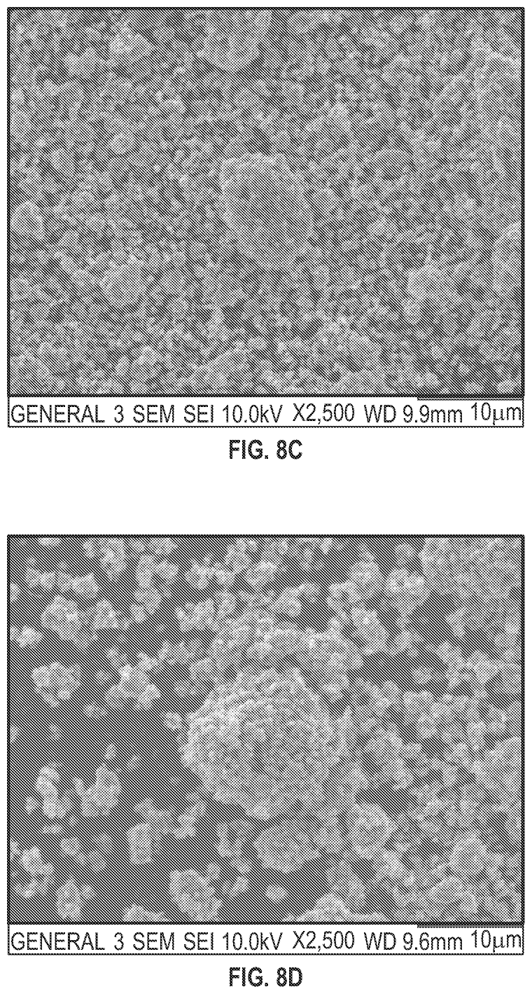

Electrode fabrication with the BASE and LFP-PAA-1 powder systems was the next step. It was readily noticeable that the BASE system with no granulation was very difficult to spray with the ESD system. The electrode layer was significantly thicker (thickness was about 2 mm) than a NCM or LCO powder system. The LFP-PAA-1 powder system was also difficult to spray, which was expected considering the similarities in bulk density. Particle size of the two materials was also found to be very similar based on SEM images (FIGS. 8A and 8B). When compared to the original LFP granules (FIGS. 6A-6D), it is obvious that the LFP has been broken apart during the high-speed mixing process; therefore, the original LFP granules were mixed with PVDF and C65 again, but at a lower tip speed to help retain granulate formation (referred to as LFP-PAA-2). Bulk density measurements showed a dramatic increase to 1.03 g/cm³ (FIG. 7) and a corresponding higher fill ratio at 30%.

As anticipated, the electrode fabrication for LFP-PAA-2 was significantly better than the prior LFP mixes. An electrode was readily made and could be used for electrochemical testing. However, it was found that the larger LFP granulates caused calendering issues and surface defects on the electrode. To alleviate this issue, an additional batch of LFP granules were formed using the same method previously presented. Afterwards, the LFP granules were reduced in size to more closely resemble other types of active materials that do not require granulation. The size reduction was achieved by ensuring that the LFP granules were completely dry and then added to the mixer. The mixing tip speed was selected such that the granules were not completely reduced to the original particle size, but high enough to effectively reduce the granulate size.

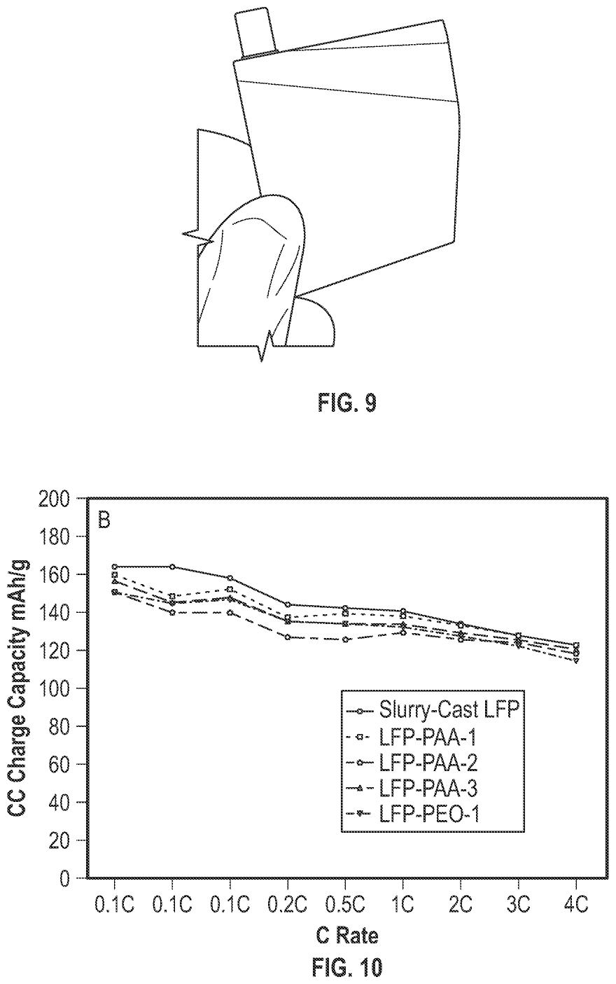

Subsequently, the LFP granules were mixed with PVDF and C65 (referred to as LFP-PAA-3). The bulk density and fill ratio were found to be 0.559 g/cm³ (FIG. 7) with a fill ratio of 16%. Both values are in between the two extremes of minimal granulation (LFP-PAA-1) to oversized granules (LFP-PAA-2). SEM images (FIG. 8C) also show granule sizes in between the two extremes (minimal granulation in FIG. 8B and oversized granulation in FIG. 8D). Electrode fabrication with LFP-PAA-3 was readily completed (FIG. 9).

To show that granulation binder could be interchangeable, Polyethylene Oxide (PEO) was used in place of PAA and the process was repeated (referred to as LFP-PEO-1). As can be seen by FIG. 8D, the particle size of the final granulation is similar to that of LFP-PAA-3 in FIG. 8C. The bulk density and fill ratio of the LFP-PEO system was also similar at 0.655 g/cm3 and 19%, respectively. Electrode fabrication was also readily completed and used for electrochemical testing.

Testing of the electrodes started with adhesion testing. A slurry-cast LFP electrode 10 was fabricated as a comparison point. The slurry-cast LFP electrode had a pull-off failure force equal to about 39.3 N while the LFP-PAA-3 electrode had a failure force equal to about 37.1 N. The LFP-PEO-1 electrode was noticeably lower at 18.9 N. While the PEO electrode had lower adhesion performance, it was still strong enough to be handled and used for electrochemical testing.

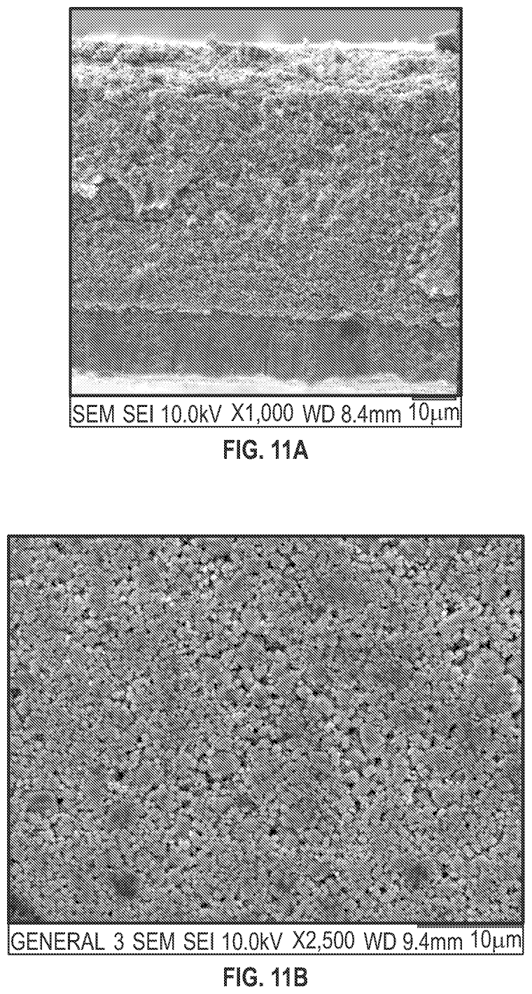

Rate performance was completed on all the electrodes previously detailed. All electrodes demonstrated relatively similar performance (FIG. 10) when compared to the slurry-cast control electrode. Cross-section and top-surface SEM images of a solvent-free LFP electrode using ultra-fine LFP are provided in FIGS. 11A and 11B.

In summary, several goals were achieved in this study. First, composite granules with an ultra-fine active material and binder were successfully fabricated. Next, the granulated particles demonstrated improved processibility (chargeability and flowability) when compared to the non-granulated ultra-fine particles. Lastly, it was shown that the granulated powder system demonstrated similar mechanical and electrochemical performance when compared to an electrode fabricated using the conventional slurry-cast manufacturing process.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A method of fabricating an electrode for electrochemical energy storage devices, the method comprising:
a. forming agglomerates from ultra-fine active particles that include one or more binder I materials;
b. forming composite particles by combining the agglomerates with one or more binder II materials;
c. depositing the composite particles onto an electrically conductive substrate through an electrostatic deposition process to form a coating layer; and
d. densifying the coating layer and the electrically conductive substrate to form an electrode.

2. The method according to claim 1, wherein an average particle size (D50) of the ultra-fine active particles is less than 5 μm

3. The method according to claim 1, wherein the ultra-fine active particles are either cathode materials or anode materials.

4. The method according to claim 3, wherein the cathode materials are selected from (i) lithium transition metal oxides, lithium transition metal sulfides, lithium polyanion cathode materials, including lithium transition metal phosphates, lithium transition metal silicates, or combinations thereof, or from (ii) sodium transition metal oxide, sodium polyanion cathode material, Prussian Blue Analogues cathode materials, or combinations thereof.

5. The method according to claim 3, wherein the anode materials are selected from (i) carbonaceous anode materials, graphite, Si, Si-based composites, SiOx, lithium alloyable materials, lithium transition metal oxide anode materials, or combinations thereof, or from (ii) sodium ion intercalation anode materials, including Prussian Blue Analogues anodes, and sodium metal transition metal oxide anodes.

6. The method according to claim 1, wherein the one or more binder I materials are selected from one or more of polymeric materials, conductive polymer materials, polymer electrolytes, solid state electrolyte composites, and carbonaceous materials.

7. The method according to claim 6, wherein the polymeric materials are selected from polyvinylidene fluoride, polytetrafluoroethylene, polyethylene oxide, poly(methyl methacrylate), polystyrene butadiene rubber binder, carboxymethyl cellulose binder, polyacrylic acid, or combinations thereof.

8. The method according to claim 1, wherein the one or more binder II materials are selected from one or more of polymeric materials, polymer electrolytes, solid state electrolyte composites, and carbonaceous materials.

9. The method according to claim 1, wherein the one or more binder I and the one or more binder II materials are the same materials.

10. The method according to claim 1, wherein the one or more binder I and the one or more binder II materials are different materials.

11. The method according to claim 1, wherein the agglomerates are formed from the one or more binder I materials and one or more additives, and wherein the one or more additives are electric conductive materials selected from carbon black, carbon nano fiber, carbon nano tube, graphene, graphite, metallic powders, or combinations thereof.

12. (canceled)

13. The method according to claim 1, wherein the composite particles are formed from the one or more binder II materials and one or more additional additives, and wherein the one or more additional additives are electric conductive materials selected from carbon black, carbon nano fiber, carbon nano tube, graphene, graphite, metallic powders, or combinations thereof.

14. (canceled)

15. The method according to claim 1, further comprising incorporating the electrode into an assembly selected from a group consisting of a rechargeable lithium battery, a Li-ion battery, a rechargeable lithium sulfur battery, a solid state battery, a rechargeable sodium battery, and a sodium-ion battery.

16. An electrode formed by the method of claim 1.

17. A method of making composite particles including ultra-fine active materials, the method comprising:
(i) mixing the ultra-fine active materials particles with one or more binder I materials to produce agglomerates; and
(ii) mixing the agglomerates with one or more binder II materials.

18. The method according to claim 17, comprising at step (i) mixing the ultra-fine active material particles with the one or more binder I materials and one or more additives to produce the agglomerates.

19. The method according to claim 17, comprising at step (ii) mixing the agglomerates with the one or more binder II materials and one or more additional additives.

20. The method according claim 17, wherein the one or more binder I materials are added as a dry powder, a solution, and/or a suspension.

21. (canceled)

22. (canceled)

23. The method according claim 17, wherein the mixing in step (i) is carried out with heating.

24. The method according claim 17, wherein the mixing in step (i) is carried out without heating.
